(19) United States
(12) Patent Application Publication
(10) Pub. No.: US 2004/0111678 A1
(43) Pub. Date: Jun. 10, 2004

(54) Method for retrieving documents

(76) Inventors: Masaaki Hara, Osaka (JP); Jugo Noda, Ikeda (JP)

Correspondence Address: MATTINGLY, STANGER & MALUR, P.C., SUITE 370, 1800 DIAGONAL ROAD, ALEXANDRIA, VA, 22314, US

(21) Appl. No.: 10/646,775

(22) Filed: Aug. 25, 2003

(30) Foreign Application Priority Data
Oct. 1, 2002 (JP) 2002-288202

(51) Int. Cl. G06F 17/00; G06F 7/00; G06F 17/30

(52) U.S. Cl. 715/526; 707/3

(57) ABSTRACT

In a concept search, the user cannot easily create an effective seed document own his/her own. Further, the concept search trainer automatically changes the weights assigned to characteristic terms; however, such changes may not always increase the retrieval accuracy. The document retrieval method of the present invention uses thesaurus data to support the user's seed document creation in a first search cycle and presents newly extracted characteristic terms to the user in second and subsequent search cycles. The retrieval accuracy increases because the present invention provides a user interface that permits seed document adjustment.

### BACKGROUND OF THE INVENTION

The present invention relates to a method for retrieving documents with a computer.

With an increased use of electronic documents in recent years, there is a rising need for efficiently retrieving desired information from an enormous number of documents.

A method used with a conventional retrieval system is to specify the conditions (retrieval expression) and retrieve documents that satisfy the conditions. This method is based on an idea in which the information (documented data) demanded by a user would be found among the results that are obtained when information (documented data) is searched for in accordance with a word that is likely to appear frequently within the information (documented data) demanded by the user. However, an efficient retrieval expression cannot easily be formed by users on their own if they are not familiar with document searches.

One solution for the above problem is to conduct a concept search in which a document (herein after referred to as a seed document) is entered instead of a retrieval expression. A technology for conducting a search in accordance with a user-entered document is disclosed by JP-A No. 339346/2000. This technology examines a seed document, extracts characteristic words (hereinafter referred to as characteristic terms) from the seed document, assigns appropriate weights to the characteristic terms, calculates the degree of conformity of documents targeted for a search in accordance with the weighted characteristic terms, picks up documents whose degree of conformity is higher than a predetermined value, and displays them as the search result.

Another technology, which is disclosed by Japanese Patent Laid-open No. 2001-117937, allows a user to determine whether character strings extracted as a result of a concept search are relevant, and causes a search processing unit (hereinafter referred to as a concept search trainer) to change the weights assigned to characteristic terms contained in the character strings and conduct a search again.

### SUMMARY OF THE INVENTION

In a conventional concept search, a large number of documents irrelevant to a user are hit. Therefore, it is difficult for the user to locate a truly desired document by examining each retrieved document. One cause of such difficulty lies in a user-entered seed document. If the words contained in the seed document significantly differ from those contained in documents targeted for a search, a concept search cannot extract valid characteristic terms.

Further, the concept search trainer automatically changes the weights assigned to characteristic terms that are contained in documents subjected to a user's relevancy check. However, such changes may not always increase the retrieval accuracy. The reason is that the characteristic terms referenced by the user for document relevancy check purposes do not coincide with characteristic terms whose weights are changed by the concept search trainer, which uses a statistical technique.

It is an object of the present invention to enhance the document retrieval accuracy by making characteristic terms for use in a search readily extractable and by tuning the characteristic terms.

A computer-based document retrieval method of the present invention receives a seed document input from a user, memorizes first characteristic terms extracted from the seed document, memorizes second characteristic terms extracted from the result of a document search process performed according to the seed document, and displays the difference between the first and second characteristic terms on screen.

To solve the problems about the document retrieval accuracy attained by a concept search, the document retrieval method of the present invention performs the following steps:

(1) Displays characteristic terms that are contained in documents targeted for a search.

(2) Combines the characteristic terms displayed in step (1) above and enters the resulting combination as a seed document for a concept search.

To solve the problems about the document retrieval accuracy of the concept search trainer, the document retrieval method of the present invention performs the following steps:

(3) Examines the characteristic terms that are contained in documents subjected to a user's relevancy check, and displays the examined characteristic terms whose weights should be changed.

(4) Allows the user to examine the characteristic terms displayed in step (3) above and specify whether their weights should be changed.

(5) Changes the weights assigned to only the characteristic terms whose weight changes are user-specified in step (4) above.

### BRIEF DESCRIPTION OF THE DRAWINGS

FIG. 1 shows a configuration according to one embodiment of the present invention;

FIG. 2 illustrates display screen transitions and processes according to one embodiment;

FIG. 3 shows an example of a word selection screen;

FIG. 4 shows an example of a seed document editing screen;

FIG. 5 shows an example of a concept search trainer screen;

FIG. 6 shows an example of a characteristic term selection screen;

FIG. 7 shows an example of a training result screen;

FIG. 8 is a flowchart illustrating the display processes of the word selection screen and seed document editing screen;

FIG. 9 is a flowchart illustrating the display process of the concept search trainer screen;

FIG. 10 is a flowchart illustrating the display process of the characteristic term selection screen; and

FIG. 11 is a flowchart illustrating the display process of the training result screen.

### DESCRIPTION OF THE PREFERRED EMBODIMENT

One embodiment of the present invention will now be described. First of all, the configuration of a system according to the present embodiment will be described.

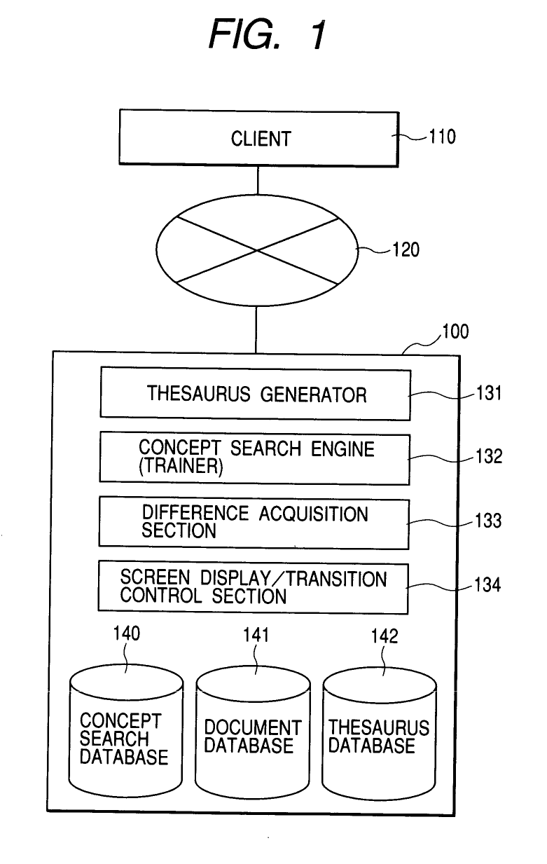

A document retrieval system of the present embodiment is configured as shown in FIG. 1. A retrieval system 100 is accessed by a client 110, which a user uses to conduct a search via a communications link 120. However, some other means of access such as a radio communications link may be used.

The retrieval system 100 includes the programs for a thesaurus generator 131, a concept search engine (concept search trainer) 132, a difference acquisition section 133 for acquiring the difference between characteristic terms, and a screen display/transition control section 134 as well as a concept search database 140, a document database 141, and a thesaurus database 142.

The processing sections 131-134 are implemented by their respective independent programs or by the functions of modules contained in a certain program. The databases 140 to 142 may be storage devices readable via a network or other devices. The characteristic terms constitute the information that contains the words for use in a search.

The client 110 and the retrieval system 100 are both computers, which include hardware resources (CPU, memory, storage device, etc.) and software resources (OS, application programs, etc.) that are required for implementing the present invention. The client 110 may alternatively be a mobile terminal if it enables the user to open necessary screens and enter various data with a browser and other application software.

The thesaurus generator 131 accesses the thesaurus database 142 to acquire words in a specific thesaurus category. The concept search engine 132 acquires characteristic terms from a seed document and performs a search process in the manner disclosed by Japanese Patent Laid-open No. 2000-339346.

The difference acquisition section 133 acquires the difference between characteristic terms used for two search and the call to this processing section 133. Alternatively, the characteristic terms used for a certain search and the characteristic terms used for another search may be stored in respective recording devices in order to let the difference acquisition 133 acquire the difference between such two sets of characteristic terms. The screen display/transition control section 134 provides control over the screens used for a search and their transitions.

The concept search database 140 stores indexes that are used for a concept search process. The document database 141 stores documents targeted for a search. The thesaurus database 142 stores words that are classified according to thesaurus categories.

The thesaurus data stored in the thesaurus database describes the scopes covered by keywords used for information searches and the relationships (synonymous, antonymous, inclusive, and other relations) between keywords for searches and words related to the keywords.

The databases 140 to 142 may alternatively be stored in a networked server instead of the server for the programs.

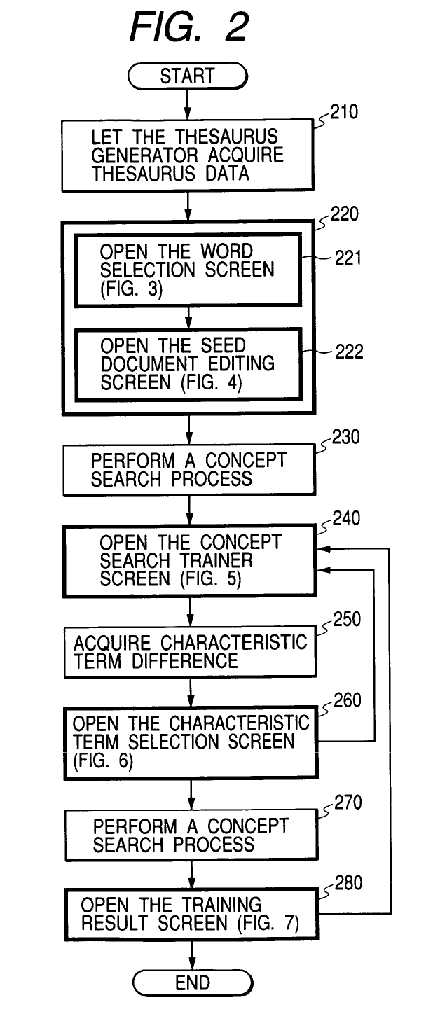

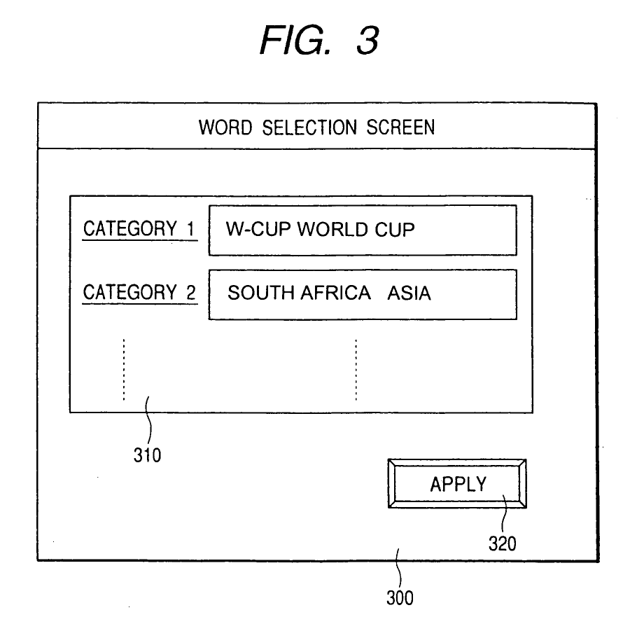

The processing steps performed by the retrieval system of the present embodiment will now be described with reference to FIG. 2. In the present embodiment, the document retrieval process is performed in the sequence indicated in FIG. 2. In step 210, the thesaurus generator 131 reads the thesaurus data stored in the thesaurus database 142. In step 220, a word input for a search is received from the user. In step 221, the user uses a word selection screen (FIG. 3) to select a thesaurus category that is similar to the contents of the document to retrieve.

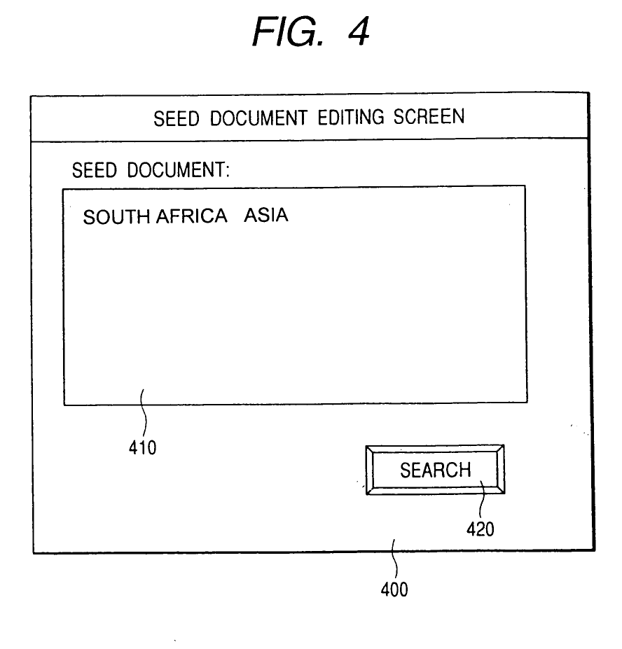

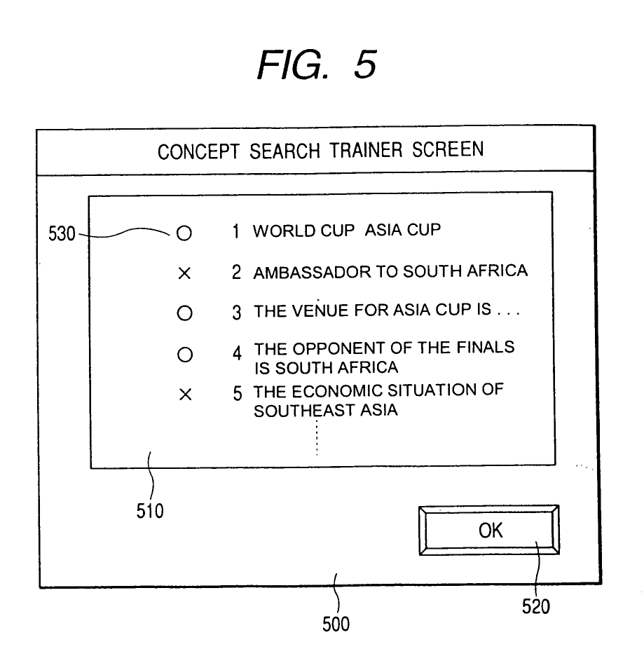

In step 222, the user uses a seed document editing screen (FIG. 4) to create a seed document in accordance with the word selected in step 211. After the seed document is created by the user, the concept search engine 132 performs a concept search process in step 230. In step 240, the result of step 230 is output to a concept search trainer screen (FIG. 5).

In step 250, a characteristic term difference acquisition process is performed by comparing the words (first characteristic terms) that were selected or additionally entered by the user when the seed document editing screen (FIG. 4) was open in step 222 against the words (second characteristic terms) that were extracted from a user-selected document when the concept search trainer screen (FIG. 5) was open in step 240.

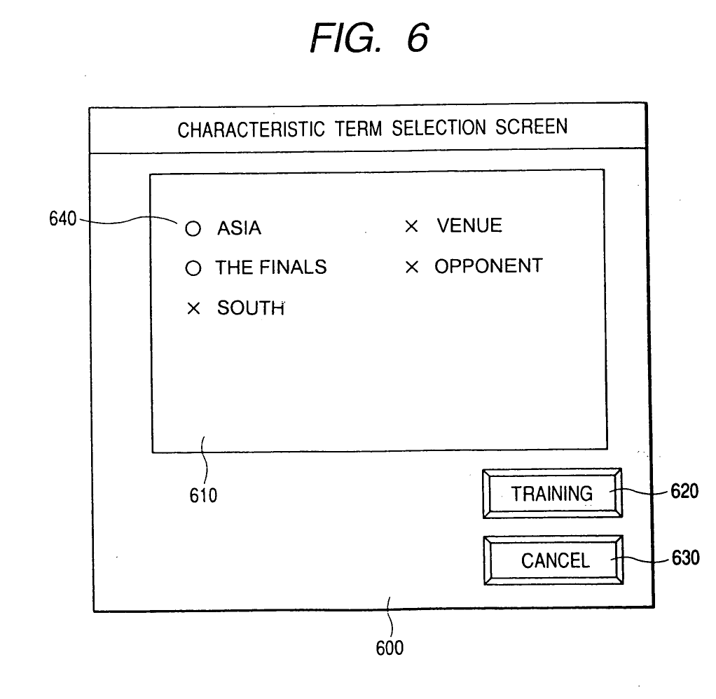

In step 260, relevant retrieved items are selected by the user then characteristic terms nonexisting at a concept search process stage in step 230 are clarified, and the characteristic terms to be used for a concept search process in step 270 appear on a characteristic term selection screen (FIG. 6). That is, step 260 is performed to display the characteristic terms that were extracted in step 250 above. In step 260, the user can eliminate words irrelevant to the search as the characteristic terms to be excluded from the concept search process that is to be performed subsequently in step 270. In step 260, user-selected characteristic terms can be stored and retained as the characteristic terms (which appear on the display in step 240) for use in the next search. After completion of characteristic term selection, the concept search process is performed in step 270.

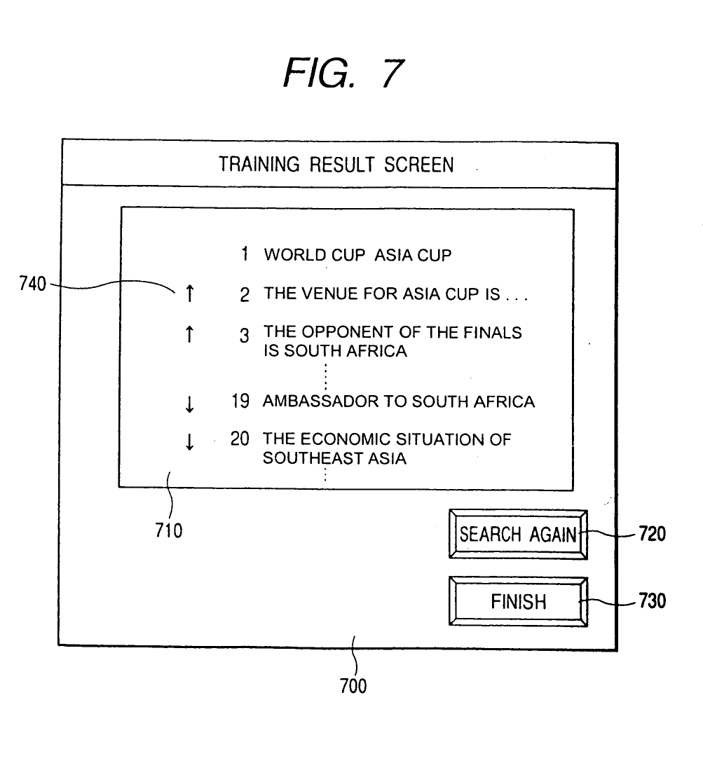

In step 280, a training result screen (FIG. 7) opens to display the result of step 270. When a satisfactory search result is obtained, the system terminates. If a search is to be conducted again, the system returns to step 240 in which the concept search trainer screen (FIG. 5) is open, and repeat the above process until a satisfactory search result is obtained.

The contents of the screens described above may be presented to the user through a Web browser or like program running on a computer for the client 110. Further, the computer for the client 110 may be used in a different manner to access the retrieval system 100 and perform steps necessary for the retrieval process.

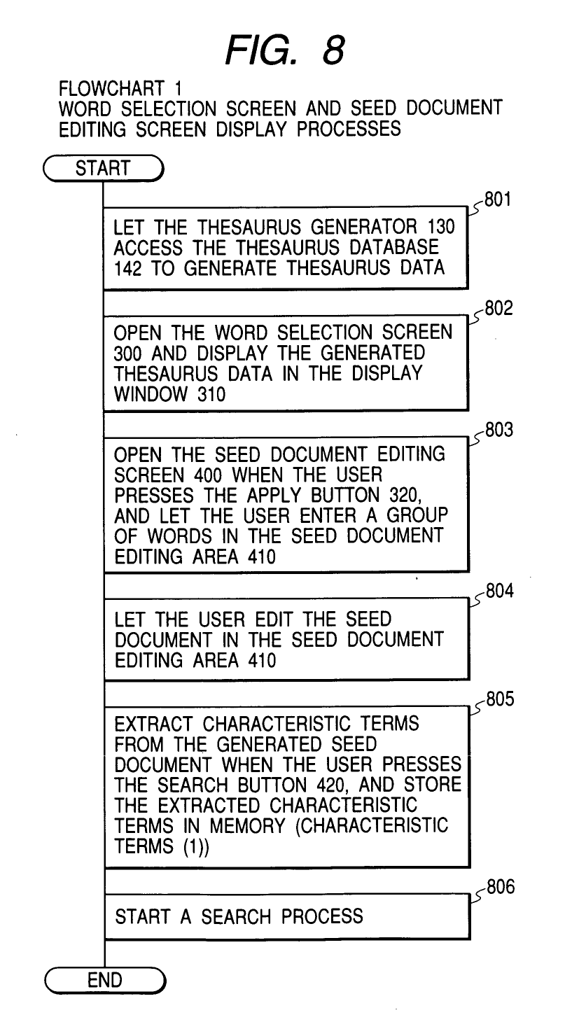

The individual processing steps will now be described in detail with reference to the typical screen contents shown in FIGS. 3 to 7 and the typical flowcharts shown in FIGS. 8 to 11.

Upon system startup, the screen display/transition control section 134 opens a word selection screen 300 shown in FIG. 3. Alternatively, the retrieval system 100 may be stored in a storage device for the retrieval system 100 as a file displayable by a Web browser, and a Web browser program running the client 110 may access the retrieval system 100 via a network to open a page shown in FIG. 3 as the display screen to be presented to the user.

A display window 310 in the word selection screen 300 shows information according to thesaurus categories, which the thesaurus generator 131 has acquired from the thesaurus database 142. The user selects a word group relevant to the information to be retrieved, and then press the Apply button 320.

Upon receipt of an instruction that is issued at the press of the Apply button 320, the system opens a seed document editing screen 400 shown in FIG. 4. The selected word group is already entered in a seed document editing area 410. The user can create a seed document by adding a word to, deleting a word from, and entering other text into the seed document editing area 410. Upon completion of seed document creation, the user presses the Search button 420 to start a search. When the user presses the Search button 420, the system initiates a concept search with the created seed document. The storage device in the retrieval system 100 stores the first characteristic terms generated in this process (hereinafter referred to as characteristic terms (1)).

Flowchart 1, which is shown in FIG. 8, illustrates the processing steps that are performed upon system startup to receive a user-entered seed document, conduct a concept search in accordance with the received seed document, and store the received seed document.

FIG. 8 is a flowchart that illustrates the display processes of the word selection screen and seed document editing screen.

In step 801, the thesaurus generator 131 accesses the thesaurus database 142 and reads the thesaurus data stored in the thesaurus database.

In step 802, the screen display/transition control section 134 opens the word selection screen 300 shown in FIG. 3. The display window 310 presents the read thesaurus categories. The user selects a displayed thesaurus category that is similar to the contents of the document to retrieve.

When the user presses the Apply button 320 in step 803, the screen display/transition control section 134 opens the seed document editing screen 400 shown in FIG. 4. The seed document editing area 410 of the seed document editing screen 400 displays a group of words.

In step 804, the user edits or creates a seed document within the seed document editing area 410.

When the user presses the Search button 420 to start a search in step 805, the concept search engine 132 receives an instruction for starting a search and extracts characteristic terms from the created seed document. The extracted characteristic terms (characteristic terms (1)) are then stored in a temporary storage area.

In step 806, the concept search engine uses the extracted characteristic terms to initiate a concept search process.

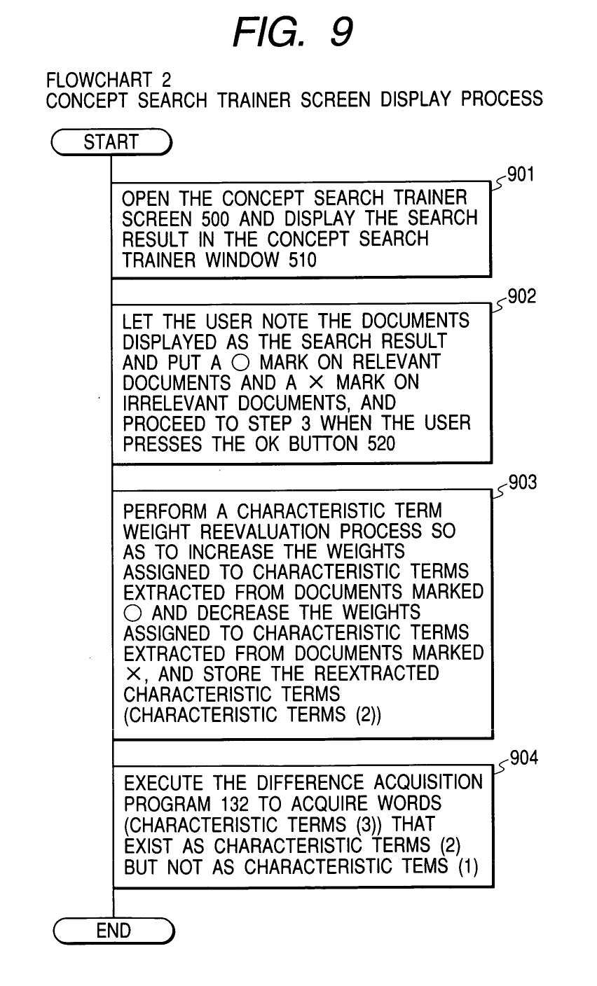

The process to be performed subsequently to the concept search process, which has been described with reference to FIGS. 4 and 8, will now be described with reference to FIGS. 5 and 9.

Upon completion of the concept search process, the system opens a concept search trainer screen 500, which is shown in FIG. 5, and displays the search result in the concept search trainer window 510.

Next, the search result will be trained. First of all, the user notes the displayed documents, which are ranked according to the concept search result, and sorts out relevant documents from irrelevant ones. More specifically, the user puts a ◯ mark on relevant documents and a X mark on irrelevant documents. These marks are to be placed in the ◯X input fields 530 within the concept search trainer window 510. When the user subsequently presses the OK button 520, a characteristic term reevaluation process starts.

The second characteristic terms (hereinafter referred to as characteristic terms (2)), which are generated upon reevaluation, are saved and compared against characteristic terms (1). More specifically, the difference acquisition section 133 acquires words that emerge as characteristic terms (2) and have not existed as characteristic terms (1). Flowchart 2, which is shown in FIG. 9, illustrates the processing steps that are performed subsequently to the opening of the concept search trainer screen 500.

FIG. 9 is a flowchart that illustrates how the contents of the concept search trainer screen change.

In step 901, the screen display/transition control section 134 opens the concept search trainer screen 500. The search result appears in the concept search trainer window 510.

In step 902, the user notes the documents displayed as the search result and puts a ◯ mark on relevant documents and a X mark on irrelevant documents. When the user presses the OK button 520, the system proceeds to step 903.

In step 903, the screen display/transition control section 134 performs a characteristic term weight reevaluation process so as to increase the weights assigned to characteristic terms extracted from documents marked ◯ and decrease the weights assigned to characteristic terms extracted from documents marked X. The characteristic term weight reevaluation process includes a process for changing the weight information, which is stored for specific characteristic terms in accordance with user-entered instructions. Reextracted characteristic terms (characteristic terms (2)) are then stored.

In step 904, the difference acquisition section 133 acquires words (characteristic terms (3)) that exist as characteristic terms (2) but not as characteristic terms (1).

Upon completion of the characteristic term difference acquisition process, a characteristic term selection screen 600 shown in FIG. 6 opens. Although characteristic terms (2) appear in a characteristic term selection window 610, words classified as characteristic terms (3) are differentiated from the other displayed words (the size of the characters is increased in FIG. 6 for the present embodiment). Thanks to this display process, the user can recognize the words that are newly added as the characteristic terms in accordance with the user's ◯X marking to represent a new search concept, and correct the search target field as needed.

The user puts a X mark in a ◯X marking field 640 for a word that is not required for the next search (a word that will not be used as a characteristic term for the next training). By default, all the words are marked ◯. The retrieval accuracy can be increased by selecting characteristic terms as described above prior to a training process.

When the user presses the displayed Training button 620, the concept search engine 132 receives a group of words marked ◯ as a seed document and initiates a concept search process with the received word group handled as the seed document.

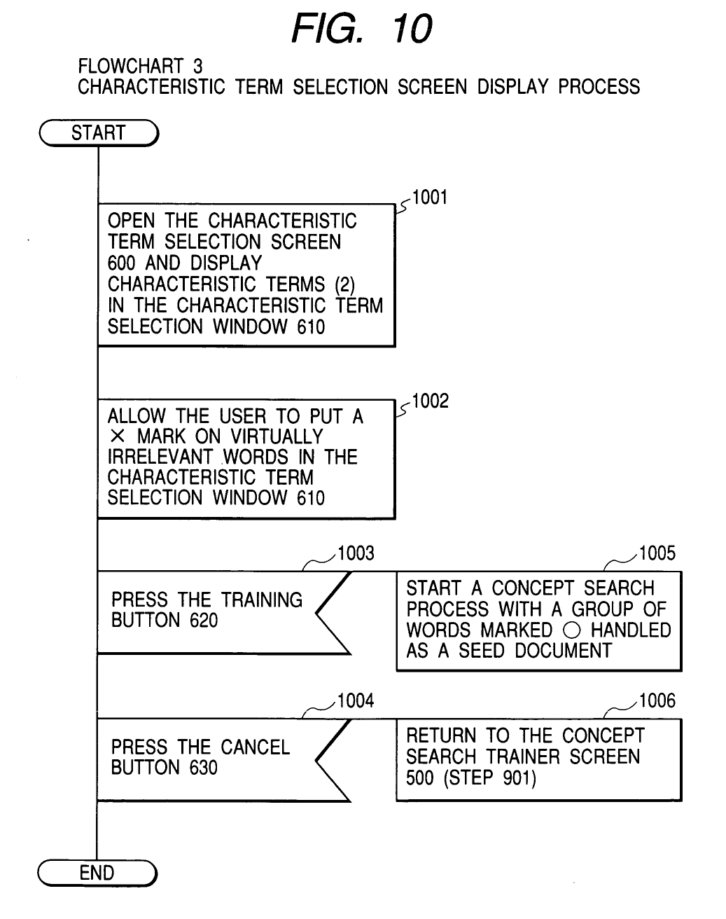

If the user presses the displayed Cancel button 630, the system returns to the preceding concept search trainer screen 500, allowing the user to mark the documents again (by putting a ◯ or X mark on them). Flowchart 3, which is shown in FIG. 10, illustrates the processing steps that are performed subsequently to the opening of the characteristic term selection screen 600.

FIG. 10 is a flowchart that illustrates how the contents of the characteristic term selection screen change.

In step 1001, the screen display/transition control section 134 opens the characteristic term selection screen 600. Characteristic terms (2) appear in the characteristic term selection window 610. Words classified as characteristic terms (3) are differentiated from the other displayed words. The ◯ mark is to be put in all the ◯X marking fields 640.

In step 1002, the user checks whether the words in the characteristic term selection window 610 are relevant to the information to be retrieved, and then puts a X mark on virtually irrelevant words.

When the user presses the displayed Training button 620 in step 1003, the concept search engine 132 receives a group of words marked ◯ as a seed document from the client 110, and initiates a concept search process with a group of received input words handled as a seed document (step 1005).

When the user presses the Cancel button 630 in step 1004, the system returns to the concept search trainer screen 500 (step 1006).

The search result appears in a training result display window 710 in a training result screen 700 shown in FIG. 7. Arrows appear to the left of newly ranked documents (appear in rank change display fields 740) to indicate whether the documents are raised or lowered in rank. The documents may be ranked according to the number of characteristic terms contained in the documents, the weights assigned to the characteristic terms contained in the documents, or some other method.

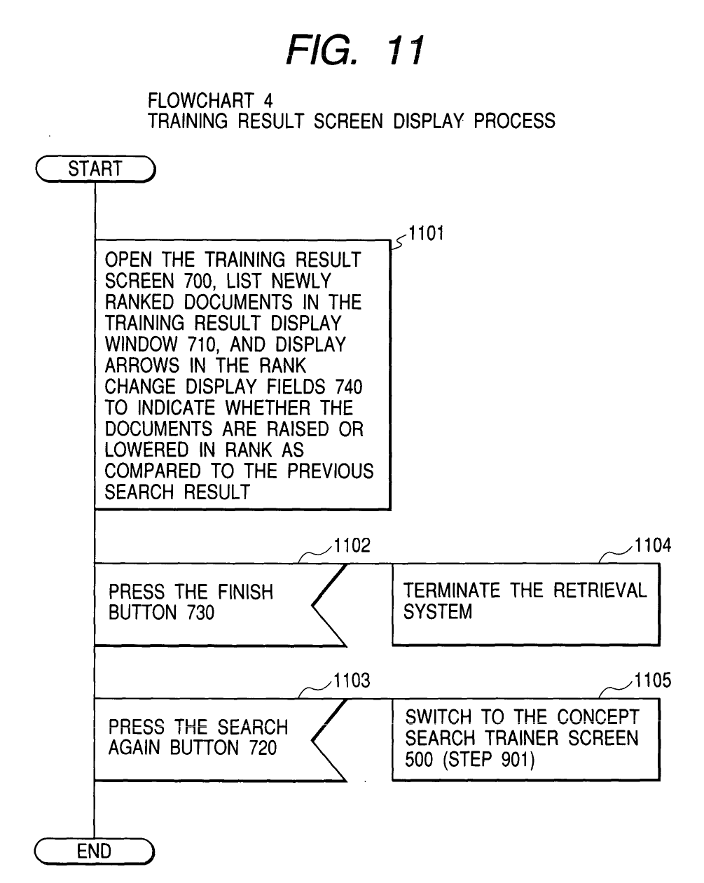

The user views the displayed search result. To terminate the search, the user presses the Finish button 730. To conduct a search again, the user presses the Search Again button 720. When the user presses the Search Again button 720, the display switches from the training result screen 700 to the concept search trainer screen 500. Flowchart 4, which is shown in FIG. 11, illustrates the processing steps that are performed subsequently to the opening of the training result screen 700.

FIG. 11 is a flowchart that illustrates how the contents of the training result screen change.

In step 1101, the screen display/transition control section 134 opens the training result screen 700. Newly ranked documents appear in the training result display window 710, and arrows appear in the rank change display fields 740 to indicate whether the documents are raised or lowered in rank as compared to the previous search result.

When the user presses the Finish button 730 in step 1102, the retrieval system terminates (step 1104).

If the user presses the Search Again button 720 in step 1103, the screen display/transition control section 134 exercises control (step 1105) so that the system initiates a display process for the concept search trainer screen 500 (step 901).

Subsequently, the system repeatedly performs steps 901 to 1101 (all the steps required for putting the ◯ and X marks to the documents and generating a search result output) until the user is satisfied with the obtained search result.

A program for executing the foregoing document retrieval method of the present invention can be stored on a computer-readable storage medium, loaded into memory, and executed.

The present invention enhances the document retrieval accuracy attained by a concept search because the seed document can be created while using characteristic terms contained in documents targeted for a search.

In situations where a search is conducted using the concept search trainer with the search field specifically narrowed, the above-described method of allowing the user to directly specify the characteristic terms to be subjected to a weight change can be additionally used to retrieve relevant documents through a decreased number of search cycles.

Further, in situations where a wide range of information is to be retrieved, characteristic terms that were not extracted by the previous search but are extracted by the current search can be presented to the user and employed as a new search concept for the next search to retrieve a wide variety of information.

In a conventional concept search, the user cannot easily create an effective seed document own his/her own. Further, the concept search trainer automatically changes the weights assigned to characteristic terms; however, such changes may not always increase the retrieval accuracy.

However, the present invention uses the thesaurus data to support the user's seed document creation in the first search cycle and presents newly extracted characteristic terms to the user in the second and subsequent search cycles. The retrieval accuracy increases because the present invention provides a user interface that permits seed document adjustment.

For example, the display screen shows thesaurus category information, which is stored in a storage device beforehand, so that the user views the displayed information and enters the instructions concerning characteristic terms or a seed document. It means that the user can conduct a search with ease because he/she does not have to enter new words. Further, characteristic terms are extracted from a previously obtained search result and displayed on screen. Therefore, the user can view the displayed characteristic terms to enter the instructions concerning the characteristic terms for use in the next search or select and enter important words. Further, these instructions from the user can be memorized so that the obtained search results will be reflected in the next search.

When the user selects or adjusts (tunes) the seed document and characteristic terms in the above manner, the source information for a search can be created minutely to fit the user's need. The retrieval accuracy can be enhanced by examining the search results and selecting important information and characteristic terms essential for document retrieval.

The present invention also enhances the retrieval accuracy attained by a concept search because it can compare initial characteristic terms, which are created from characteristic terms in a document prior to a search process, against characteristic terms extracted from the result of the search process, determine the difference between these two sets of characteristic terms, and apply the difference to the characteristic terms for use in the next search process.

Alternatively, the present invention may be used to compare characteristic terms extracted from a plurality of search processes and apply the result of comparison to the characteristic terms for use in the next search.

Further, in situations where the present invention is used to retrieve a wide range of information, characteristic terms that were not extracted by the previous search but are extracted by the current search can be presented to the user and employed as a new search concept for the next search to retrieve a wide variety of information.

As described above, the present invention enhances the retrieval accuracy by tuning the characteristic terms for use in searches.

What is claimed is:

1. A computer-based document retrieval method, comprising the steps of:
receiving a seed document entered by a user;
memorizing first characteristic terms extracted from said seed document;
memorizing second characteristic terms extracted from the result of a document search process performed on said seed document; and
displaying the difference between said first characteristic terms and said second characteristic terms on screen.

2. A program for executing a method for electronic document retrieval, wherein said method comprises the steps of:
receiving a seed document entered by a user;
memorizing first characteristic terms extracted from said seed document;
memorizing second characteristic terms extracted from the result of a document search process performed on said seed document; and
displaying the difference between said first characteristic terms and said second characteristic terms on screen.

3. An electronic document retrieval system, comprising:
means for receiving a seed document entered by a user;
means for memorizing first characteristic terms extracted from said seed document and second characteristic terms extracted from the result of a document search process; and
means for displaying the difference between said first characteristic terms and said second characteristic terms on screen.

4. A computer-based document retrieval method, comprising the steps of:
memorizing first characteristic terms extracted from the result of a first search process;
memorizing second characteristic terms extracted from the result of a second search process which is performed on the result of said first search process;
comparing said first characteristic terms and said second characteristic terms; and
displaying the result of said comparison on screen.

5. A computer-based document retrieval method, comprising the steps of:
displaying characteristic terms extracted from the result of a document search process on screen;
receiving a user's instruction for selecting said displayed characteristic terms; and
memorizing the received instruction for selecting said characteristic terms.

6. A computer-based document retrieval method, comprising the steps of:
causing thesaurus category information, which is stored in a storage device beforehand, to appear on screen;
receiving a user's instruction for selecting said displayed thesaurus category information; and
performing a document search process in accordance with the received instruction for selecting said thesaurus category information.

7. A computer-based document retrieval method, comprising the steps of:
receiving first characteristic terms from a user;
performing a search process on said first characteristic terms and displaying the result of said search process on screen;
receiving second characteristic terms which are entered by the user in accordance with the result of said search process;
comparing said first characteristic terms and said second characteristic terms; and
displaying the result of said comparison on screen.

8. A document retrieval support method according to claim 7, wherein displayed characteristic terms classified solely as said second characteristic terms are differentiated from the other characteristic terms when said first characteristic terms and said second characteristic terms are compared.

9. The document retrieval support method according to claim 7, wherein characteristic terms classified solely as said second characteristic terms are assigned an increased weight setting when said first characteristic terms and said second characteristic terms are compared.

10. A computer-based document retrieval method, comprising the steps of:
receiving first characteristic terms entered by a user;
performing a first search process on said first characteristic terms and displaying the result of said first search process on screen;
receiving second characteristic terms which are entered by the user in accordance with the displayed result of said first search process;
comparing said first characteristic terms and said second characteristic terms; and
performing a second search process in accordance with the result of said comparison.

11. The document retrieval method according to claim 10, wherein said second search process performed in accordance with the result of said comparison comprises the steps of:
memorizing, as third characteristic terms, the characteristic terms that are not listed as said first characteristic terms but are listed as said second characteristic terms;
assigning relatively great weights to said third characteristic terms; and
performing said second search process in accordance with said second characteristic terms and said third characteristic terms.

12. A computer-readable storage medium storing a program for executing a computer-based document retrieval method, wherein said method comprises the steps of:
receiving a seed document entered by a user;
memorizing first characteristic terms extracted from said seed document;
memorizing second characteristic terms extracted from the result of a document search process performed on said seed document; and
displaying the difference between said first characteristic terms and said second characteristic terms on screen.
